(19) United States
(12) Patent Application Publication
(10) Pub. No.: US 2009/0121401 A1
(43) Pub. Date: May 14, 2009

(54) Vibration damping assembly for a pulley that drives an auxiliary unit of a motor vehicle

(75) Inventors: Steffen Lehmann, Ettlingen (DE); Dimitri Sieber, Ettlingen (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/287,683

(22) Filed: Oct. 13, 2008

Related U.S. Application Data
(63) Continuation of application No. PCT/DE07/00521, filed on Mar. 22, 2007.

(30) Foreign Application Priority Data
Apr. 13, 2006 (DE) 10 2006 017 157.8

(51) Int. Cl. F16F 15/123

(52) U.S. Cl. 267/215

(57) ABSTRACT

Disclosed is an assembly for damping vibrations on a wheel that is used for driving a secondary unit of a vehicle. Said assembly comprises a damping device on the driving wheel that is mounted on a hub which is connected to a drive shaft of the secondary unit. A torsional vibration damper that is combined with a friction clutch is provided as a damping device. The friction clutch is fitted with at least one friction surface facing the hub and at least one second friction surface facing the friction ring in order to non-positively and/or positively couple the driving wheel to the hub via the damper cage of the torsional vibration damper such that torque is transmitted in a vibration damping manner from the driving wheel to the hub via the damper cage. The second friction surface is located between a plate spring and a support disk. The plate spring is connected to the damper cage while the support disk is connected to the hub. Also disclosed is an assembly encompassing several combined torsional vibration dampers. In addition, an assembly with fixed stops can be provided for transmitting high starting torques. Finally, an additional friction damping device is supplied on an assembly.

The present invention relates to an assembly for damping vibrations on a pulley used for a secondary unit of a vehicle, with a damping device on the driving pulley mounted on a hub.

German patent document DE 195 35 889 A1, for instance, discloses an apparatus for damping vibrations in traction means. The traction means is intended for belt drive of an internal combustion engine unit, wherein a freewheeling clutch is disposed between a pulley and a shaft. The known freewheeling unit is suitable, particularly, for driving a generator. The freewheeling unit is a part of a pulley used for driving the generator. The application of the freewheeling unit facilitates internal damping so that the transmission of torque is improved in the traction means.

European patent document EP 0 980 479 B1 discloses a further belt drive system with a freewheeling clutch connected to a generator. A torsional coil spring and one-way clutch mechanism form the drive system so that the created mechanism in the form of a screw-shaped coil has dual function. On the one hand, generator pulley driving torque can be transmitted resiliently to the hub and on the other hand, the generator pulley can be disconnected in one direction from the hub.

In general, belt drives are provided for driving secondary units, e.g., a generator, a water pump, an AC compressor, a servo-steering pump or the like in an internal combustion engine. Due to non-uniform rotations of the crankshaft or driving mechanism in an internal combustion engine, high loads can be transmitted from the belt drive to the secondary unit. These loads are dependent on the height of the excitation amplitude, on the stiffness of belt and belt tensioner and on the rotational inertia of secondary units, wherein the rotational inertia of the alternator or generator bears a relatively large share of the total rotational inertia. Therefore, it is required that the secondary unit be disconnected from the belt drive.

The object of the present invention is to improve an assembly for damping vibrations of the generic type mentioned at the beginning.

This object is met, for instance, by means of an assembly for damping vibrations on a driving pulley for driving a secondary unit of a vehicle. A damping device on the driving pulley is mounted on a hub, wherein the hub is connected with a drive shaft of the secondary unit. A torsional vibration damper combined with a safety-friction clutch is provided as a damping device. Thus, the safety-friction clutch comprises at least a friction surface on the hub side and at least a friction surface on the friction-ring side. The friction surfaces couple the driving pulley with the hub in a non-positive and/or positive manner, and with the damper cage of the torsional vibration damper, so that vibration-damped transmission of torque from the driving pulley to the hub is enabled by means of the damper cage. According to the invention, it can be made possible that the friction-ring side of the friction surface is disposed between a plate spring and a support disk, wherein the plate spring is connected with the damper cage and the support disk with the hub.

In practice, it has been apparent that the safety-friction clutch used in known assemblies is thermally heavy-loaded. In the assembly according to the invention, this is prevented by shifting at least the friction contact on the friction-ring side or by shifting the friction surface on the friction-ring side. The friction surface on the friction-ring side of the assembly according to the invention is hence provided between the plate spring and the support disk. By virtue of the plate spring being disposed between the friction ring and damper cage, it can improve the heat transfer in the assembly according to the invention, so that thermal overload, particularly, in the friction-surfaces section of the safety-friction clutch is certainly avoided.

Within the scope of a preferred embodiment of the present invention, the plate spring and support disk are made of a material with a high thermal conductivity value, e.g., steel or the like. As such, the friction heat generated on the friction surface of the safety-friction clutch can be optimally absorbed and dissipated in the axial direction on both sides by the components, e.g., made of steel, thus from the plate spring and support disk. In this manner, thermal insulation provided in a common assembly is avoided by using a damper cage that is generally made of plastic.

Moreover, the plate spring lies directly on the damper cage, advantageously preventing the damper cage from flexing as is common in known assemblies. In this manner, the spring force of the plate spring can be transmitted directly onto the cone without additional lever-arm.

According to a next development, it can be provided that the plate spring is splined on the internal diameter of the damper cage, projecting in the axial direction. This support disk, on the other hand, can be connected with the hub by means of caulking or splines. Other types of design are possible for assembling the plate spring and support disk in a respectively non-rotational manner. As an axial locking device for individual components, for instance, it can be provided that the friction ring is clamped axially with the support disk.

In the assembly according to the invention, the damper cage together with the driving pulley preferably form pockets for arcuate coil springs of the torsional vibration damper formed as arcuate coil spring dampers. The angular deflection of the arcuate coil spring damper springs can be limited by means of corresponding limit stops. These limit stops are preferably disposed between the pulley and the damper cage.

The prior described embodiment of the assembly can be combined also with at least one of the following described embodiments.

The object of the invention is also met by an assembly for damping vibrations on a driving pulley for driving a secondary unit of a vehicle. Thus, with a damping device on the driving pulley mounted on a hub, wherein the hub is connected with a drive shaft of the secondary unit, wherein the damping device is combined with a safety-friction clutch so that vibration-damped transmission of torque is provided from the driving pulley to the hub. According to the invention, the damping device comprises several torsional vibration dampers or the like for achieving predetermined damping capacity for the transmission of torque between the driving pulley and the hub.

It is possible to realize the embodiment of the present invention in connection with the prior mentioned embodiment or also independently for the embodiment.

Through this further assembly, the damper-spring stiffness of the utilized torsional vibration damper can be adapted to desired engine applications. This can be achieved particularly in that the angular deflection of the torsional vibration damper can be changed by means of an appropriate combination of different torsional vibration dampers.

According to a particularly preferred arrangement of the invention, it can be provided that at least two torsional vibration dampers are connected in series between the driving pulley and the hub. For instance, it is also considerable that the torsional vibration dampers are connected in parallel. At the same time, other arrangements of individual torsional vibration dampers are possible, wherein the dampers can be connected both in series and in parallel.

It has been evident that a series connection of the torsional vibration dampers is advantageous for certain engine applications that require significantly less damper-spring stiffness. Through a series connection of torsional vibration dampers, the spring stiffness can be reduced, for instance, by half.

A possible design version of a series connection of torsion vibration dampers can be realized in that two damper cages are disposed in series in the axial direction or the like, in order to be able to accommodate spring elements of the respective torsional vibration dampers. Preferably, arcuate coil spring dampers can be used as torsional vibration dampers. However, also other torsional vibration dampers are applicable.

The damper cages disposed in series in the axial direction form pockets for the respective arcuate coil springs of the arcuate coil spring dampers, wherein the angular deflection of the arcuate coil springs of each arcuate coil spring damper is limited by means of limit stops. Due to the series connection of arcuate coil spring dampers, the maximum angular deflection is doubled by adding both angular deflections of individual arcuate coil spring dampers. Due to the change of the number of utilized arcuate coil spring dampers, it is possible to adapt the total angular deflection to a specific application.

Irrespective of whether or not a torsional vibration damper or an arcuate coil spring damper, or a similar damper is now used, the assembly according to the invention can be realized by means of the damper cage of the friction clutch element. Thus, the element acts in at least one rotation direction of the drive wheel to absorb the vibration amplitudes during the transmission of torque from the driving pulley to the hub. In the process the damper cages provided are pressed axially, via at least one first friction surface, against the hub for non-positive torque transmission. For instance, the first friction surface for non-positive torque transmission can be formed as a conical surface or the like. It is also considerable that the friction surface for positive torque transmission is formed as an axially toothed surface.

To seal the assembly in the axial direction according to the invention, a covering cap can be provided at least on the support disk side.

The object of the invention is also met by an assembly for damping vibrations on a driving pulley for a secondary unit of a vehicle. Thus, with a damping device on the driving pulley mounted on a hub, wherein the hub is connected with a drive shaft of the secondary unit, wherein the damping device comprises a torsional vibration damper so that vibration-damped torque transmission is provided from the driving pulley to the hub. According to the invention are corresponding fixed stops or the like provided for the assembly respectively on the driving pulley and on the hub, the fixed stops limit the angular deflection of the torsional vibration damper. These fixed stops are also designated as characteristic stops that are particularly suitable for transmission of high starting engine torques.

This further possible embodiment can be combined under certain circumstances at least partly with the above-mentioned embodiments, but they can also be used independently.

In particular, for starter generators with the so-called hybrid systems, it can be necessary that relatively low driving torque is required in generator operation, whereas, at the start of the internal combustion engine, also engine operations mode, a substantially higher torque must be transmitted. In particular, for these applications, it is advantageous to use solid fixed stops for the assembly according to the invention, instead of a safety-friction clutch.

Within the scope of a preferred arrangement of the present invention can the driving pulley, formed as pulley or the like, comprise a first damper-cage half, which forms pockets with a second damper-cage half, for the spring-loaded storage of the torsional vibration dampers formed, e.g., as arcuate coil spring dampers.

Preferably, the first damper-cage half can be pressed inside the pulley. To establish a positive connection between the first damper-cage half and the pulley can the first damper-cage half feature several protrusions or the like on its outside diameter, the protrusions can engage positively in recesses between the fixed stops on the pulley. It is also possible that the second damper-cage half, e.g., features internal toothing which is coupled with the hub by means of the external toothing or the like. Thus, a splined connection is obtained between the first damper-cage half and the pulley.

As a splined connection between the second damper-cage half and the hub, according to the next arrangement of the invention, it can be provided that the second damper-cage half is coupled positively with the hub via interposed toothing.

A next development of the invention it can be provided that in the assembly according to the invention, in the axial direction between the first damper-cage half and the second damper-cage half, a distancing washer or the like is used. The distancing washer prevents direct contact between the two damper-cage halves, which are made of plastic, for instance. Since the distancing washer is preferably made of steel, a plastic/plastic friction contact is as such avoided.

For axial fastening it can be provided in the assembly according to the invention, for instance, that a support disk and/or a locking ring is provided, which presses the two housing halves or damper-cage halves against one another. For axial sealing, covering caps or the like can be provided on each side of the assembly.

Corresponding fixed stops on the hub and pulley have the effect that the starting torque of the internal combustion engine is transmitted directly by means of these limit stops. This embodiment of the assembly can be combined with prior described embodiments. It is also possible that the described embodiment is used separately.

The object of the invention is also met by an assembly, wherein the prior described embodiment is complemented at least by a friction damping device or the like. By this means can the prior described embodiment with fixed stops be improved in such a manner that the so-called belt squeals and inadvertent resonances on the assembly are prevented by an additional friction-damping device.

Within the scope of a preferred arrangement of the present assembly, this further embodiment of the friction-damping device can comprise a plate spring or the like, in which the spring force on the one side is supported on the support disk and on the other side on the second, damper-cage half or respectively acts on it. By this means, at least two friction surfaces for friction damping are disposed between the pulley and the hub. In particular is a first friction surface formed between the first damper-cage half and the hub and a second friction surface is provided between the distancing washer and at least one of the two damper-cage halves. Therefore, the additional friction damping of the assembly is to be set accordingly, by means of the force of spring plate.

The prior described embodiment of the assembly according to the invention can be combined preferably with the embodiment wherein the fixed stops between the pulley and the hub are used for torque transmission with damped vibration. However, also other combinations with further described embodiments of the assembly are considerable.

Preferably, arcuate coil spring dampers operating without additional lubricant can be used as torsional vibration dampers, independently of the prior-described embodiments. Furthermore, the prior-described driving pulley can be formed preferably as pulley for driving a secondary unit and, e.g., be mounted in rotatable manner by means of a plain bearing or roller bearing on the hub. In order to have as low friction as possible in the spring element pockets or in the arcuate coil springs and hence allow for a long service life, it can be provided that the damper cages or the like forming the pockets are made of fiber-reinforced plastic. Preferably, the fiber-reinforced plastic can comprise a dry lubricant or the like. This makes additional lubricants unnecessary. To provide optimum sealing on the assembly according to the invention, a diaphragm gland or a labyrinth seal can be provided as sealing element, preferably in the intended limit stops section.

The following figures explain the present invention in detail, based on the respective drawings. The figures show the following:

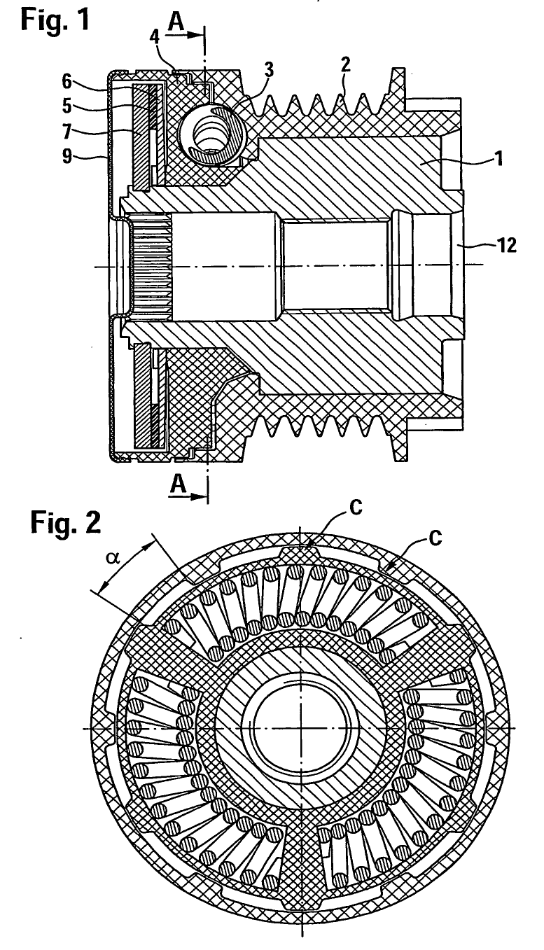

FIG. 1 is a sectional partial view of a first embodiment of an assembly for damping vibrations on a driving pulley;

FIG. 2 is a sectional view along the line of cut A-A based on FIG. 1 of the assembly according to the invention;

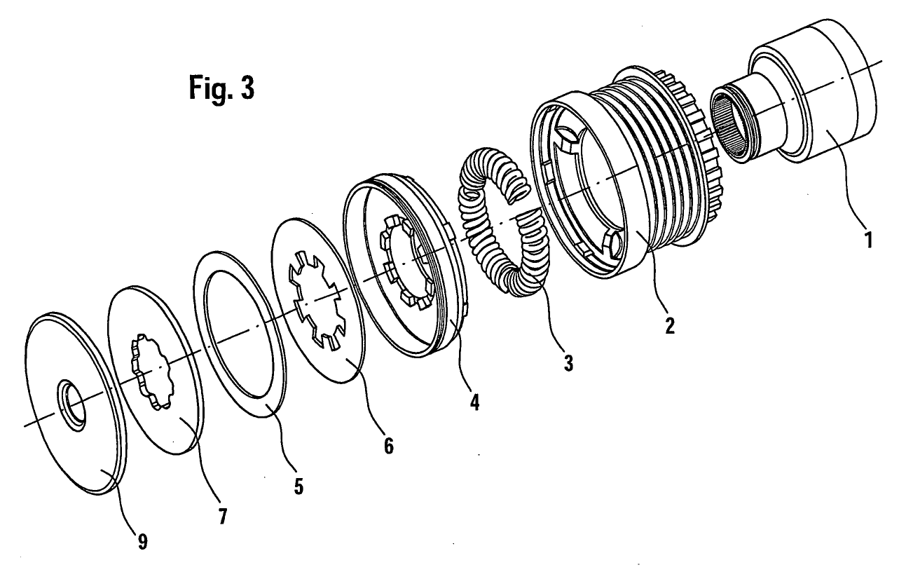

FIG. 3 is an exploded illustration of the assembly according to the invention based on FIG. 1;

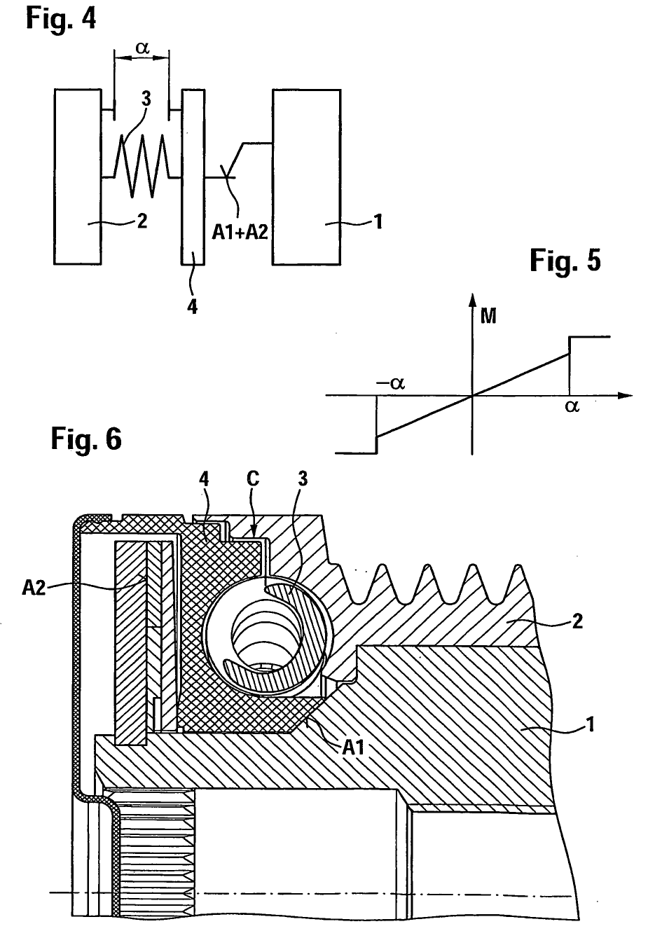

FIG. 4 is a functional diagram based on the first embodiment of the assembly;

FIG. 5 is a diagram with a characteristic line of the torque to be transmitted versus the angular deflection as a characteristic curve based on the first embodiment of the assembly;

FIG. 6 is a magnified partial view based on FIG. 1 with the friction surfaces of the safety-friction clutch;

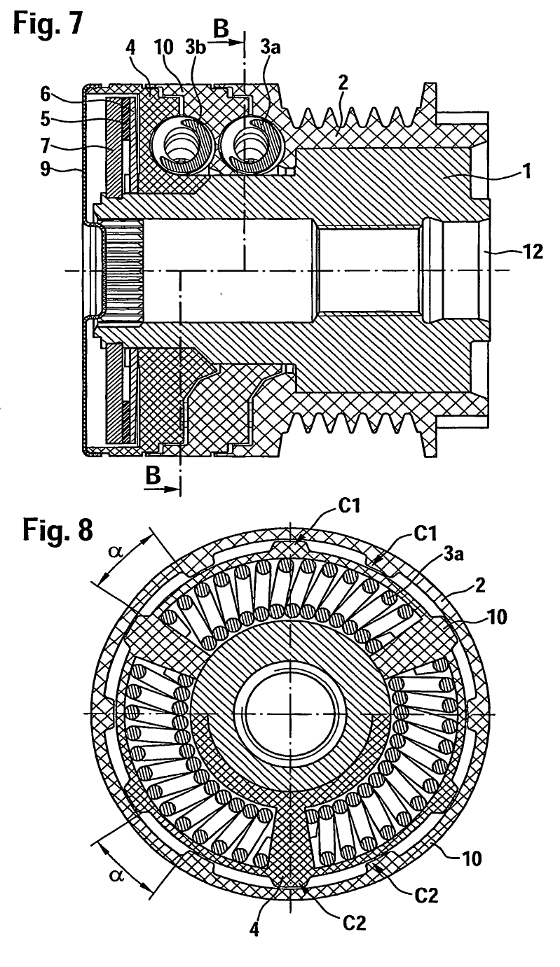

FIG. 7 is a sectional partial view of a second embodiment of an assembly for damping vibrations on a driving pulley;

FIG. 8 is a sectional view along the line of cut B-B based on FIG. 7 of the assembly;

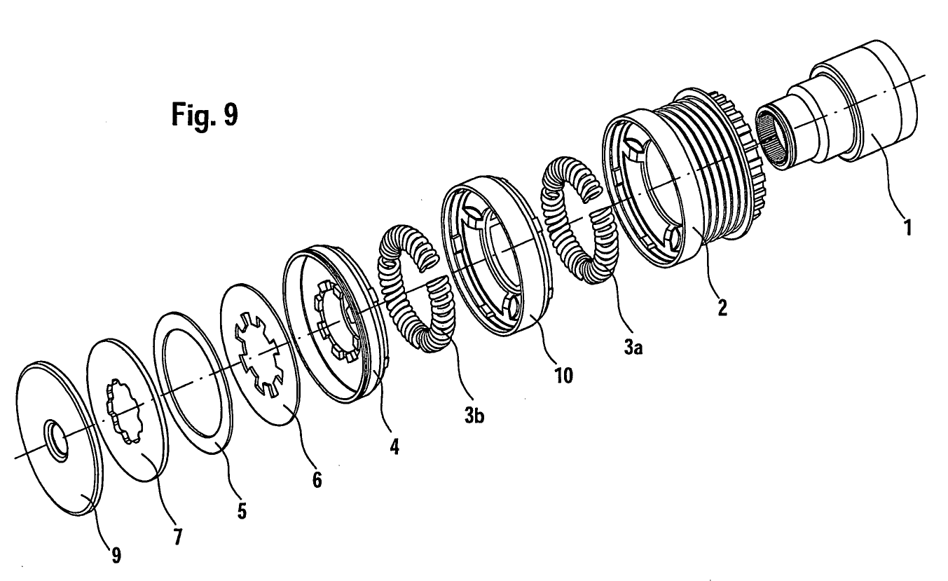

FIG. 9 is an exploded illustration of the second embodiment of the assembly;

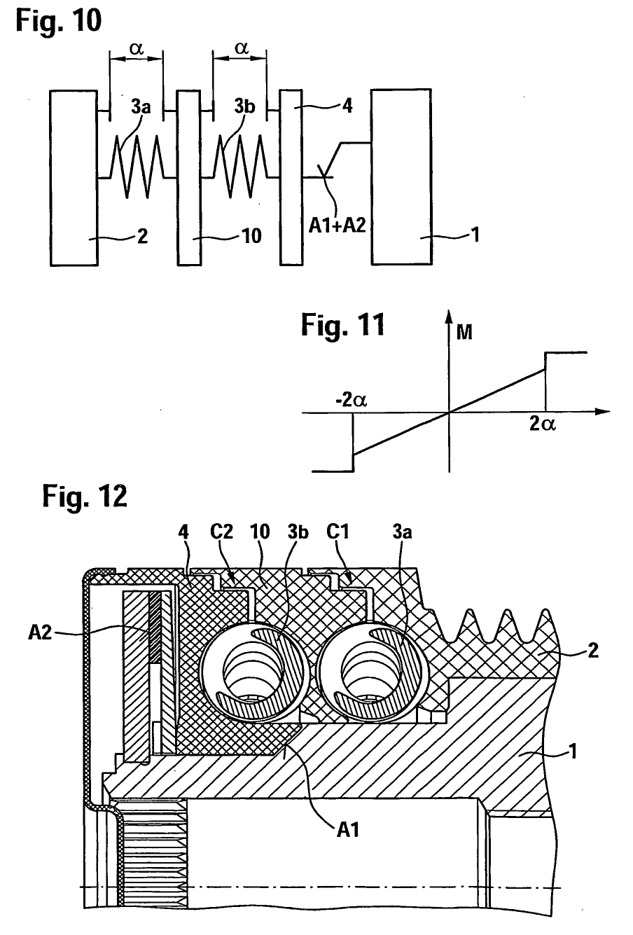

FIG. 10 is a functional diagram of the second embodiment of the assembly;

FIG. 11 is a diagram with a shape of the transmitted torque versus the angular deflection as characteristic curve of the second embodiment of the assembly;

FIG. 12 is a magnified partial view based on FIG. 7 with the respective friction surfaces of the assembly;

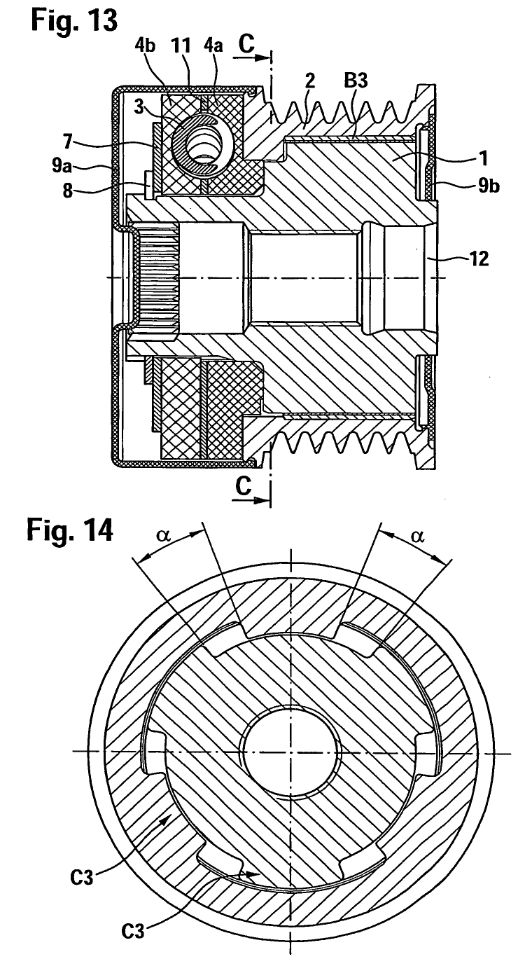

FIG. 13 is a sectional partial view of a third embodiment of an assembly for damping vibrations on a driving pulley;

FIG. 14 is a sectional view along the line of cut C-C based on FIG. 13 of the third embodiment of the assembly;

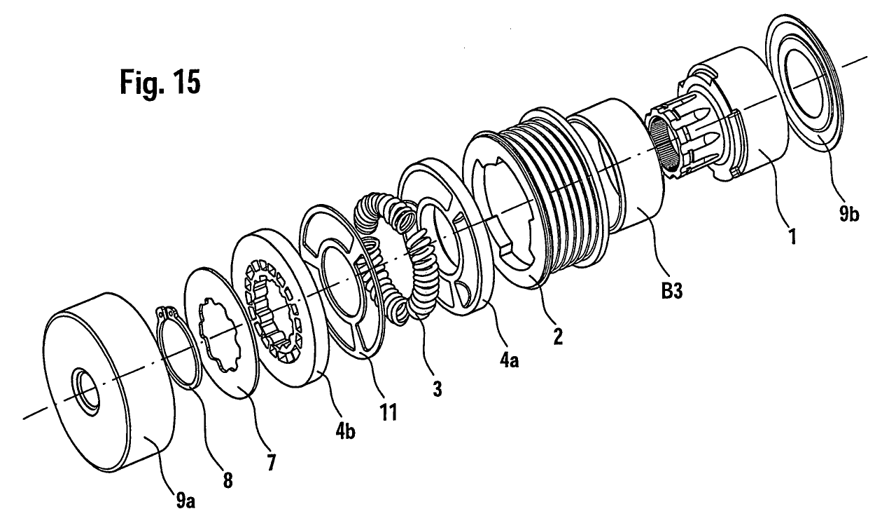

FIG. 15 is an exploded illustration of the third embodiment of the assembly;

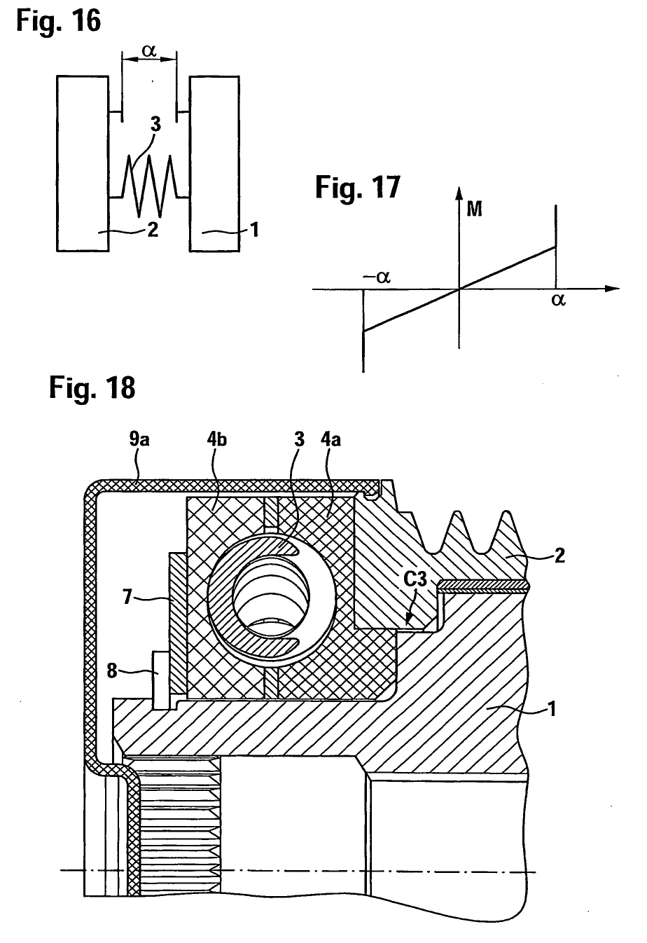

FIG. 16 is a functional diagram of the third embodiment of the assembly;

FIG. 17 is a diagram with a shape of the transmitted torque versus the angular deflection as a characteristic curve of the third embodiment of the assembly;

FIG. 18 is a magnified partial view of the third embodiment of the assembly with the exemplarily outlined fixed stop;

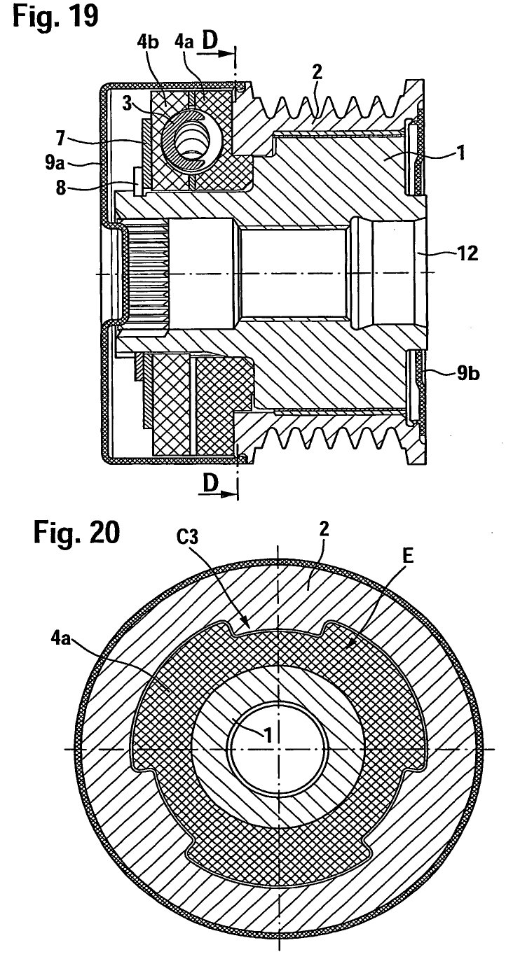

FIG. 19 is a further partial view of the third embodiment of the assembly;

FIG. 20 is a sectional view along the line of cut D-D based on FIG. 19 of the third embodiment of the assembly;

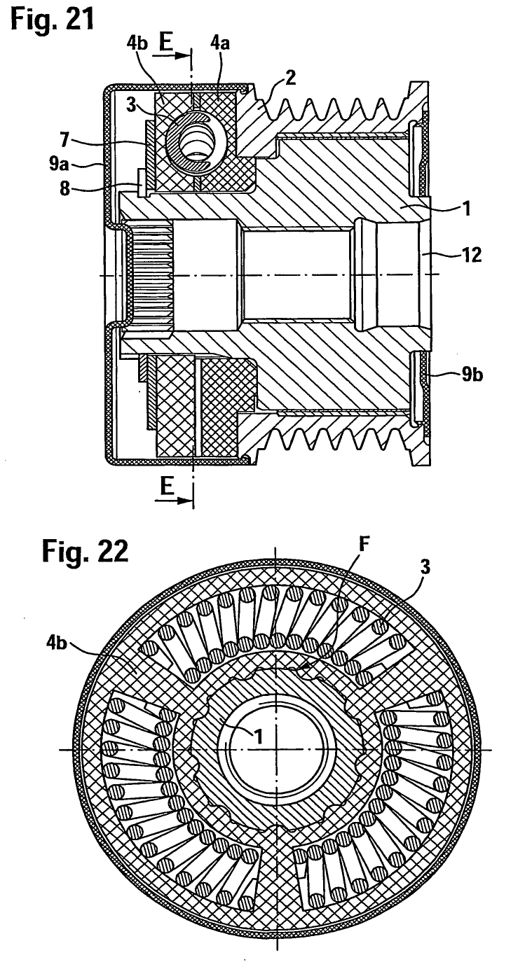

FIG. 21 is a further partial view of the third embodiment of the assembly;

FIG. 22 is a sectional view along the line of cut E-E based on FIG. 21 of the third embodiment of the assembly;

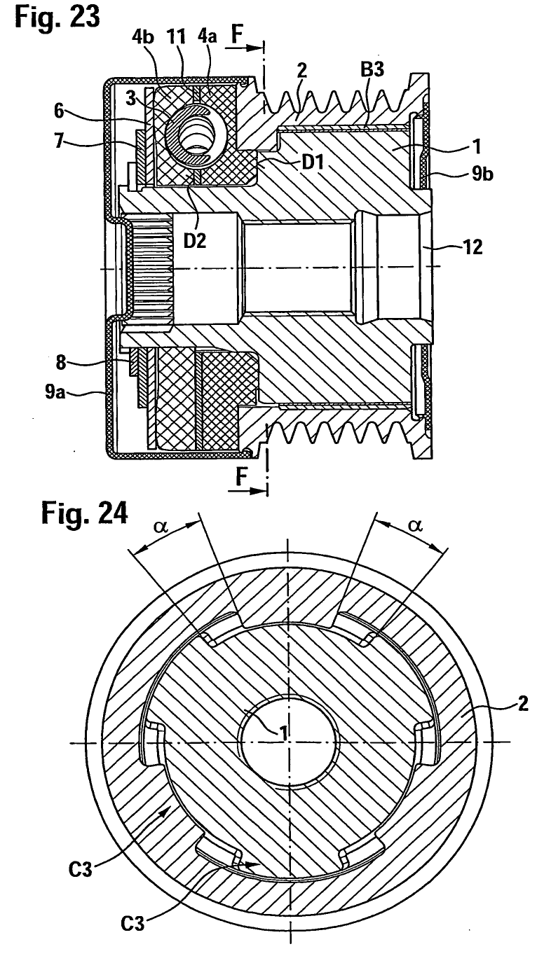

FIG. 23 is a sectional partial view of a forth embodiment of an assembly for damping vibrations on a driving pulley;

FIG. 24 is a sectional view along the line of cut F-F based on FIG. 23 of the forth embodiment of the assembly;

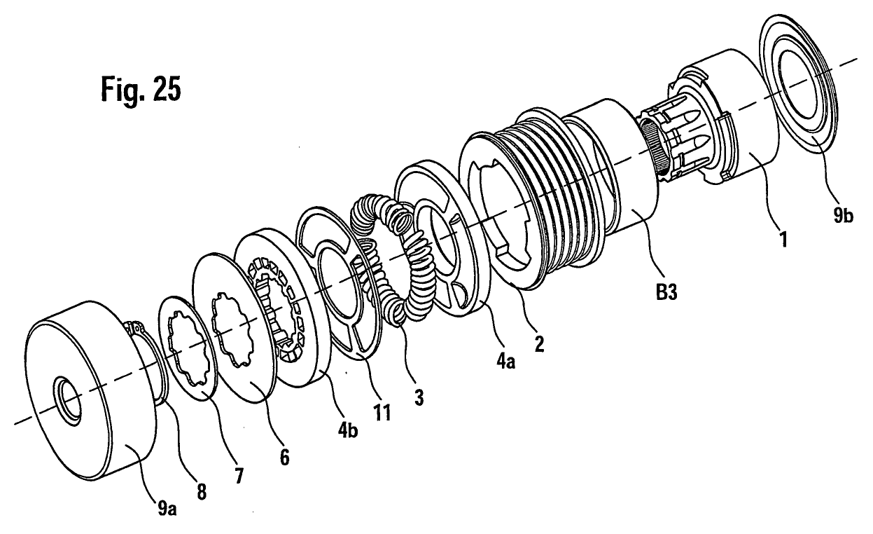

FIG. 25 is an exploded illustration of the forth embodiment of the assembly;

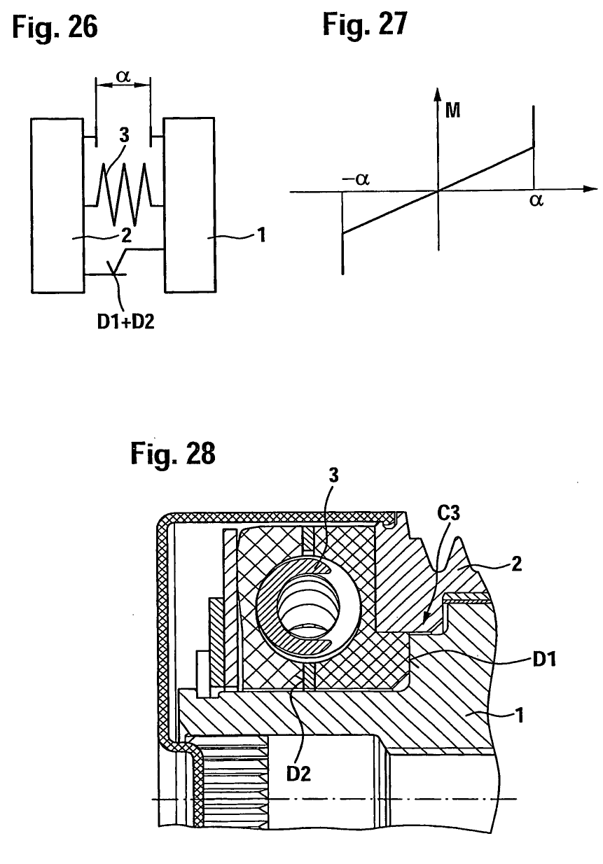

FIG. 26 is a functional diagram of the forth embodiment of the assembly;

FIG. 27 is a diagram with a shape of the transmitted torque versus the angular deflection as a characteristic curve of the forth embodiment of the assembly; and

FIG. 28 is a further sectioned partial view of the forth embodiment of the assembly with the friction surfaces of the assembly.

In FIGS. 1 to 28 four different embodiments of an assembly according to the invention are depicted; the embodiments for damping vibrations on a driving pulley for driving a secondary unit (not shown) of a vehicle with a damping device.

FIGS. 1 to 6 show a first embodiment; FIGS. 7 to 12 show a second embodiment; FIGS. 13 to 22 show a third embodiment and FIGS. 23 to 28 a forth embodiment of the assembly. In the exemplary, depicted embodiments is the driving pulley formed as pulley 2, on a hub 1 in a rotating manner. The hub 1 is connected with a drive shaft 12 of a secondary unit of an internal combustion engine designated as, e.g., a generator or an alternator or the like.

The hub 1 is preferably screwed on the drive shaft 12 via an internal thread, wherein the tightening torque is introduced by means of a hexagon or multiple teeth (e.g., serration) part or designed otherwise. Furthermore, in the depicted embodiments, an arcuate coil spring damper that operates without lubricant is used preferably as a torsional vibration damper.

In the first embodiment depicted in FIG. 1, the damping device comprises, besides the arcuate coil spring dampers, also a safety-friction clutch, which is combined with the arcuate coil spring damper. The arcuate coil spring damper features a damper cage 4, wherein the pulley 2 and the dampers cage 4 correspond with one another such that they jointly form several pockets distributed over the circumference for the arcuate coil springs 3. The pockets disposed along the circumference in a distributed manner, for the arcuate coil springs 3 are limited by corresponding limit stops C both on the damper cage 4 as well as on the pulley 2, so that a predetermined maximum angular deflection α of the arcuate coil spring dampers is prescribed as depicted in FIG. 2.

In FIG. 3, an exploded illustration of the first embodiment of the assembly according to the invention is depicted, in which the design of the assembly based on the first embodiment is clarified. The screw-connected hub 1 with the drive shaft 12 of the secondary unit accommodates the centered pulley 2 in a rotational manner, wherein the pulley 2 is again coupled to a belt or rather to the like of belt and chain for coupling it with the crankshaft drive of the internal combustion engine. In the axial direction a plate spring 6 is attached to the damper cage 4, the spring being splined on the damper cage 4. This is realized in that on the internal diameter of the damper cage 4 in the radial direction protruding noses are disposed, which are in engagement with the internal diameter of the plate spring 6. The internal contact of plate spring 6 on damper cage 4 advantageously also prevents profound flexing of the damper cage 4, since the spring force of the plate spring 6 is directly transmitted to the cone without lever-arm effect. The friction ring 5 lies on the side of plate spring 6 facing away from the damper cage 4, which is pressed by a support disk 7 against the damper cage 4. The support disk 7 is caulked with the hub 1 non-rotationally. A covering cap 9 is provided on the support disk as external protection.

In FIG. 4, the functional principle is explained based on the depicted functional diagram. Wherefrom it is apparent that the pulley 2 is coupled by means of the springs 3 of the arcuate coil spring damper in dependence on the selected angular deflection α with the damper cage 4, wherein the damper cage 4 as friction clutch element again is coupled via friction surfaces A1 and A2 with the hub 1 for vibration-damped torque transmission.

FIG. 5 shows a diagram with the resulting characteristic line in which torque transmission is based on the first embodiment of the assembly according to the invention, in the form of a diagram. From the diagram, it is apparent that the torque is achieved depending on the angular deflection, thus rising linearly up to a maximum torque to be transmitted.

In FIG. 6 is a magnified, sectioned partial view shown, based on FIG. 1, from which the functional manner, particularly, of the safety-friction clutch is apparent in the assembly according to the invention. In the assembly according to the invention is the friction contact on the friction-ring side formed by the friction surface A2 between the friction ring 5 and the support disk 7. In this manner can the friction heat generated by the safety-friction clutch be absorbed on both sides by means of steel parts, since the friction surface A2 is disposed between the components normally made of steel, namely the plate spring 6 and the support disk 7. In this manner, sufficient thermal conduction can be realized so that thermal load can be avoided.

Besides the friction surface A2, the damper cage 4 is in non-positive connection with the hub 1 via a further friction surface A1. The friction surface A1 can be executed, e.g., as a conical surface as shown in FIG. 6. Nevertheless, also positive connection between the damper cage 4 and the hub 1, for instance, in the form of a ratchet mechanism or the like is possible. In order for the damper cage 4 to serve as a friction clutch element, the damper cage 4 is clamped by means of the friction surface A2 against the hub 1 by means of the friction surface A1. This is particularly realized by means of the plate spring 6. In this manner, can the torque transmission for predetermined vibration amplitude be temporarily reduced or interrupted by the safety-friction clutch, so that vibrations are not transmitted further to the secondary unit.

In FIG. 7 is a second embodiment of the assembly according to the invention depicted. In this assembly, the damping capacity is doubled by means of a series connection of two arcuate coil spring dampers. This is therefore necessary, since in some engine applications a significantly lower level of stiffness of the damper spring is required. With the assembly according to the invention, a reduced, e.g., halved spring stiffness can be realized by simple means.

Essentially, the assembly based on the second embodiment comprises the same components as the first embodiment. However, changes have been made in the damper cage 4, section, in order to realize the series connection of the two arcuate coil spring dampers. For this purpose is the hub 1 elongated in the axial direction, so that in the axial direction two serially arranged damper cages 4, 10 can be disposed. Through the two damper cages 4 and 10 can two rows of arcuate coil springs 3a, 3b be accommodated in the pockets formed by the two damper cages 4, 10. Between the individual damper cages 4, 10 are limit stops C1, C2 provided, as visible in FIG. 8.

The corresponding limit stops C1 are provided between the pulley 2 and the damper cage 10. In contrast, corresponding limit stops C2 are disposed between damper cage 10 and damper cage 4. As such, the stops C1, C2 respectively limit the maximum angular deflection of each arcuate coil spring damper and can bear the excess torque that can occur in the slip phase of the safety-friction clutch.

In FIG. 9 is an exploded illustration of the second embodiment of the assembly according to the invention depicted. Besides the components already described with regard to the first embodiment, here, the additional damper cage 10 and the additional arcuate coil springs 3a are seen. To be able to accommodate the two damper cages 4, 10 is the hub 1 lengthened in the axial direction. Otherwise, reference can essentially be drawn to the description of the first embodiment.

The functional diagram of the second embodiment of the assembly according to the invention is shown in FIG. 10. From this functional diagram it is apparent that between the pulley 2 and the hub 1 two arcuate coil spring dampers with their arcuate coil springs 3a, 3b are connected so that the respective maximum angular deflection add up together. Consequently, for two similar arcuate coil springs, a doubled value of the angular deflection (2a) is attained. Also in the second embodiment is a safety-friction clutch provided, which is formed by the two friction surfaces A1 and A2.

In FIG. 11 is the resulting characteristic curve for the torque transmission based on the second embodiment of the assembly according to the invention depicted in a diagram. Essentially, this characteristic curve corresponds to the characteristic curve of the first embodiment, however, with the difference that the angular deflection relative to the first embodiment of the assembly is doubled, thus corresponds to 2a.

The magnified, sectioned partial view in FIG. 12 shows the second embodiment of the assembly according to the invention, in more detail. In particular, the corresponding limit stops C1 is disposed between the pulley 2 and the damper cage 10 and the corresponding C2 disposed between the two damper cages 4, 10 clearly visible. Moreover, a conical surface is disposed between the damper cage 4 and the hub 1 as the first friction surface A1 of the safety-friction clutch. As the second friction surface A2, the friction surface A2 is disposed between the friction ring 5 and the support disk 7 or plate spring 6, just as in the first embodiment based on FIG. 1. Therefore, other versions are also possible with respect to the friction surfaces A1 and A2.

In FIG. 13 is a third embodiment of the assembly according to the invention depicted. This embodiment is particularly suitable for transmission of higher engine starting torque. It has been apparent that increasingly more starting generators are used in the so-called hybrid systems instead of conventional generators. These starter generators need a relatively low driving torque in generator operation, which can be covered by means of the limit stop torque of the arcuate coil spring damper. During the starts of the an internal combustion engine, however, in engine operation mode, a significantly higher torque has to be transmitted via the arcuate coil spring damper, so that, for instance, instead of a safety-friction clutch provided in the prior described embodiments, a solid. fixed stop or the like is realized. Therefore, characteristic curve limit stops are realized for transmission of high engine starting torques.

These corresponding fixed stops are designated with C3 in the third embodiment of the assembly. In that case, corresponding limit stops C3 disposed on the hub 1 are made of steel and disposed on the pulley 2a that should likewise be made of steel. The corresponding limit stops C3 are particularly apparent in FIG. 14.

Further, the pulley 2 features a first damper-cage half 4a, which together with a second damper-cage half 4b forms pockets for the arcuate coil springs 3 of the respective damper. By this means is the first damper-cage half 4a pressed inside the pulley 2, so that the spring torque is introduced onto the arcuate coil springs 3. In the third embodiment depicted in FIG. 13 is the pulley 2 supported by means of the plain bearing 3 on the hub 1, wherein the plain bearing is likewise pressed inside the pulley 2.

The torque transmitted onto the arcuate coil springs 3 is transmitted via the second damper-cage half 4b onto the hub 1. The second damper-cage half 4b features an internal toothing that is in engagement with an external toothing on the hub 1 so that the second damper-cage half 4b is splined on the hub 1. Between the two damper-cage halves 4a and 4b is a distancing washer 11 disposed.

From FIG. 14 it is apparent that, through the corresponding limit stops C3, angular deflections α are permitted between the pulley 2 and the hub 1.

In FIG. 15 is an exploded illustration of the third embodiment of the assembly according to the invention depicted. In contrast to the prior described embodiments is a distancing washer 11 made of steel visible, which is disposed between the first damper-cage half 4a and the second damper-cage half 4b, in order to avoid a plastic/plastic-friction contact of the two damper-cage halves 4a, 4b. Furthermore, a support disk 7 and a locking ring 8 is provided for axial security and is concealed by a covering cap 9a, wherein the covering cap 9a comprises a corresponding covering cap 9b on the opposite side of the assembly, so that cleanliness of the assembly is guaranteed.

FIG. 16 shows a functional diagram based on the third embodiment of the assembly according to the invention, from which it is apparent that a safety-friction clutch is not provided between the hub 1 and the pulley 2. As a damping device, only an arcuate coil spring damper, arcuate coil springs 3, with the corresponding maximum angular deflection α is provided. From this functional diagram, one obtains a corresponding characteristic curve for torque transmission, which is depicted in FIG. 17, in the form of a diagram. By this means, the torque is depicted versus the angular deflection, and it is apparent that after attaining the maximum angular deflection α no limitation of the torque to be transmitted occurs.

In FIG. 18 is a magnified partial view of the third embodiment shown, wherein, again, the corresponding fixed stops C3 between the hub 1 and the pulley 2 are clarified.

In FIG. 19 is a further sectioned partial view of the third embodiment of the assembly shown to clarify the torque transmission from the pulley 2 to the first damper-cage half 4a. At the same time, in FIG. 20 is a sectioned illustration shown along the line of cut D-D, based on FIG. 19. From this view is the positive connection apparent between the pulley 2 and the first damper-cage half 4a, the cage being pressed inside the pulley 2. At the same time, the first damper-cage half 4a features protrusions E in the radial direction, which are pressed in recesses between the limit stops C3 of the pulley 2 in a positive connection manner. Therefore, the first damper-cage half 4a is splined on the pulley 2.

FIG. 21 shows a further sectioned partial view of the third embodiment of the assembly, which should clarify the torque transmission from the second damper-cage half 4b to the hub 1. At the same time, in FIG. 22 is a sectioned view depicted along the line of cut E-E, based on FIG. 21. From this view, one sees the positive connection between the damper cage half 4b and the hub 1, through disposed toothing F. Owing to this positive connection is the torque of the arcuate coil springs 3 transmitted to the hub 1, and thus conveyed further to the drive shaft 12.

In FIG. 23 is a sectioned partial view of a forth embodiment of the assembly according to the invention depicted. In the forth embodiment of the assembly, it is provided that the third embodiment of the assembly is complemented by a friction-damping device. This is because, under certain circumstances, undesired noises and resonances can occur due to the corresponding fixed stops. Therefore, it is an advantage to provide an additional friction-damping device.

At the same time, as suggested in FIG. 23, a plate spring 6 is provided on the second damper-cage half 4b, so that its spring force can be born on a support disk 7 on the one hand and on the other, it can be born on the second damper-cage half 4b. In this manner, a friction surface D2 is disposed between the two damper-cage halves 4a and 4b and the distancing washer 11. Moreover, the damper cage half 4a is supported on the hub 1 via a further friction surface D1. Therefore, the friction damping of the additional friction-damping device can be set accordingly by means of the provided plate spring 6.

In FIG. 24 is a sectioned view depicted along the line of cut F-F, based on FIG. 23. From this view are the corresponding limit stops C3 of the pulley 2 and the hub 1 apparent, and the maximum angular deflection α between the limit stops C3 outlined.

The exploded illustration, based on FIG. 25, is nearly identical with the exploded illustration of the third embodiment of the assembly depicted in FIG. 15, with the difference that in the forth embodiment, the plate spring 6 is additionally disposed between the support disk 7 and the second damper-cage half 4b.

FIG. 26 shows a functional diagram of the forth embodiment of the assembly, in which it is apparent that besides the arcuate coil spring damper with respective springs 3 between the hub 1 and the pulley 2, the friction damping device is provided with its two friction surfaces D1 and D2. From this, one obtains the characteristic curve of the forth embodiment of the assembly depicted in the diagram in FIG. 27.

This characteristic curve is identical with the characteristic curve of the third embodiment depicted in FIG. 17.

Finally, FIG. 28 shows a magnified sectioned partial view of the forth embodiment of the assembly, in which, particularly, the two friction surfaces D1 and D2 of the provided friction damping device are clarified. Otherwise, reference can be made to the description provided with respect to FIG. 23.

In the case of all embodiments, the driving pulley formed as pulley 2 can be preferably supported on the hub 1 in rotatable manner, by means of a plain bearing B3.

### REFERENCE NUMERALS

1 hub

2 driving pulley

3, 3a, 3b arcuate coil springs

4 damper cage

4a, 4b damper-cage half

5 friction ring

6 plate spring

7 support disk

8 locking ring

9, 9a, 9b covering cap

10 damper cage

11 distancing washer

12 drive shaft

A1 first friction surface

A2 second friction surface

B3 plain bearing

C corresponding limit stops

C1 corresponding limit stops

C2 corresponding limit stops

C3 corresponding fixed stops

D1 first friction surface

D2 second friction surface

E protrusions

F disposed toothing

α maximum angular deflection

1. A vibration damping arrangement for damping vibrations of a driving pulley that drives an auxiliary unit of a motor vehicle, said damping arrangement comprising: a damping device carried by a driving pulley that is mounted on a hub, wherein said hub is connected with a drive shaft of an auxiliary unit, wherein a torsional vibration damper combined with a safety-friction clutch is provided as a damping device, and wherein said safety-friction clutch includes at least a first friction surface on the hub side and at least a second friction surface on the friction-ring side to non-positively and/or positively couple said driving pulley through said damper cage of said torsional vibration damper with said hub, so that vibration-damped torque transmission is provided from driving pulley via said damper cage to said hub, wherein said second friction surface is disposed between the one plate spring and a support disk, wherein said plate spring is connected with said damper cage and said support disk with said hub.

2. A vibration damping arrangement in accordance with claim 1, wherein the plate spring and the support disk are made of material with high thermal conductivity.

3. A vibration damping arrangement in accordance with claim 1, wherein the plate spring is held non-rotationally on noses protruding in the axial direction, provided on the internal diameter of the damper cage.

4. A vibration damping arrangement in accordance with claim 1, wherein the support disk is connected non-rotationally with the hub by means of caulking or toothing system.

5. A vibration damping arrangement in accordance with claim 1, wherein the damper cage together with the driving pulley forms pockets for the arcuate coil springs of the torsional vibration damper formed as an arcuate coil spring damper.

6. A vibration damping arrangement in accordance with claim 5, wherein the angular deflection of the arcuate coil springs of the arcuate coil spring damper is limited by corresponding limit stops.

7. A vibration damping arrangement in accordance with claim 6, wherein the corresponding limit stops are disposed between the pulley and the damper cage.

8. A vibration damping arrangement in accordance with claim 1, wherein the friction ring is secured axially with the support disk.

9. A vibration damping arrangement for damping vibrations of a driving pulley for driving a an auxiliary unit of a motor vehicle, said damping arrangement comprising: a damping device carried by a driving pulley that is mounted on a hub, wherein the hub is connected with a drive shaft of an auxiliary unit, wherein the damping device is combined with a safety-friction clutch, so that vibration damped torque transmission is provided from said driving pulley to said hub, and wherein the damping device includes several torsional vibration dampers for attaining a predetermined damping capacity for torque transmission between said driving pulley and said hub.

10. A vibration damping arrangement in accordance with claim 9, wherein at least two torsional vibration dampers are connected in series between the driving pulley and the hub.

11. A vibration damping arrangement in accordance with claim 9, wherein at least two torsional vibration dampers are connected in parallel between the driving pulley and the hub.

12. A vibration damping arrangement in accordance with claim 10, wherein in a series connection of arcuate coil springs as a torsional vibration damper at least two damper cages are arranged in succession in the axial direction.

13. A vibration damping arrangement in accordance with claim 12, wherein the damper cages together with the driving pulley forms pockets for the respective arcuate coil springs.

14. A vibration damping arrangement in accordance with claim 12, wherein the angular deflection of the arcuate coil springs of each arcuate coil spring damper is limited by corresponding limit stops.

15. A vibration damping arrangement in accordance with claim 14, wherein the corresponding limit stops are disposed between the pulley and the damper cage, and that the corresponding limit stops are disposed between said damper cage and damper cage.

16. A vibration damping arrangement in accordance with claim 1, wherein at least the damper cage is formed by means of the friction surfaces as a friction clutch element for absorbing vibration amplitudes in torque transmission acting in at least one direction of rotation of the drive wheel.

17. A vibration damping arrangement in accordance with claim 16, wherein the damper cage is pressed axially against the hub through a first friction surface for non-positive torque transmission.

18. A vibration damping arrangement in accordance with claim 1, wherein the friction surface is formed as a conical surface for non-positive torque transmission.

19. A vibration damping arrangement in accordance with claim 1, wherein a covering cap is provided as an axial sealing element.

20. A vibration damping arrangement for damping vibrations of a driving pulley for driving a an auxiliary unit of a motor vehicle, said damping arrangement comprising: a damping device carried by a driving pulley that is mounted on a hub, wherein said hub is connected with a drive shaft of an auxiliary unit, and wherein the damping device includes a torsional vibration damper, so that vibration damped torque transmission is provided from said driving pulley to said hub, wherein on said driving pulley and on said hub corresponding fixed stops are provided for the transmission of high starting torques.

21. A vibration damping arrangement in accordance with claim 20, wherein the driving pulley formed as pulley includes a first damper-cage half which, with a second damper-cage half, forms pockets for the arcuate coil springs of the torsional vibration damper formed as an arcuate coil spring damper.

22. A vibration damping arrangement in accordance with claim 21, wherein wherein the first damper-cage half is pressed in the pulley.

23. A vibration damping arrangement in accordance with claim 21, wherein the first damper-cage half includes several protrusions on its outside diameter, said protrusions engage positively into the recesses between the fixed stops of the pulley.

24. A vibration damping arrangement in accordance with claim 20, wherein the second damper-cage half is splined with the hub by means of interposed teeth.

25. A vibration damping arrangement in accordance with claim 20, wherein a distancing washer is disposed in the axial direction, between first damper-cage half and second damper-cage half.

26. A vibration damping arrangement in accordance with claim A vibration damping arrangement in accordance with claim 20, wherein covering caps are provided as axial protective seal.

27. A vibration damping arrangement in accordance with claim 1, wherein at least a friction-damping device is provided.

28. A vibration damping arrangement in accordance with claim 27, wherein the friction-damping device comprises plate spring, of which the spring force acts on a support disk and on the second damper-cage half.

29. A vibration damping arrangement in accordance with claim 27, wherein the friction-damping device comprises at least two friction surfaces (D1, D2) for friction damping between the pulley and hub.

30. A vibration damping arrangement in accordance with claim 29, wherein a first friction surface is formed between the first damper-cage half and the hub.

31. A vibration damping arrangement in accordance with claim 29, wherein a second friction surface is disposed between the distancing washer and at least one of the two damper-cage halves.

32. A vibration damping arrangement in accordance with claim 1, wherein the torsional vibration damper is formed as an arcuate coil spring damper operating without lubricant.

33. A vibration damping arrangement in accordance with claim 1, wherein the driving pulley formed as pulley is mounted on the hub in rotatable manner by means of a plain bearing or a roller bearing.

34. A vibration damping arrangement in accordance with claim 1, wherein the pulley and/or the damper cage half as spring guide elements of the torsional vibration damper are made of a fiber-reinforced plastic.

35. A vibration damping arrangement in accordance with claim 34, wherein the fiber reinforced plastic comprises dry lubricant.

36. A vibration damping arrangement in accordance with claim 1, wherein as sealing element a diaphragm gland or a labyrinth seal is provided in the section of the limit stops.

37. A vibration damping arrangement in accordance with claim 1, wherein a support disk and/or a locking ring are provided for axial fixation.
